(19) United States
(12) Patent Application Publication
(10) Pub. No.: US 2024/0054403 A1
(43) Pub. Date: Feb. 15, 2024

(54) RESOURCE EFFICIENT FEDERATED EDGE LEARNING WITH HYPERDIMENSIONAL COMPUTING

(71) Applicant: Intel Corporation, Santa Clara, CA (US)

(72) Inventors: Nikita Zeulin, Tampere (FI); Olga Galinina, Tampere (FI); Sergey Andreev, Tampere (FI); Nageen Himayat, Fremont, CA (US)

(21) Appl. No.: 18/384,525

(22) Filed: Oct. 27, 2023

Related U.S. Application Data
(60) Provisional application No. 63/452,957, filed on Mar. 17, 2023.

(51) Int. Cl. G06N 20/00

(52) U.S. Cl. CPC G06N 20/00

(57) ABSTRACT

A device to train a hyperdimensional computing (HDC) model may include memory and processing circuitry to train one or more independent sub models of the HDC model and transmit the one or more independent sub models to another computing device, such as a server. The device may be one of a plurality of devices, such as edge computing devices, edge or Internet of Things (IoT) nodes, or the like. Training of the one or more independent sub models of the HDC model may include transforming one or more training data points to one or more hyperdimensional representations, initializing a prototype using the hyperdimensional representations of the one or more training data points, and iteratively training the initialized prototype.

### PRIORITY

This application claims the benefit of priority to U.S. Provisional Application Ser. No. 63/452,957 filed Mar. 17, 2023, which is incorporated by reference herein in its entirety.

### BACKGROUND

Federated Learning has emerged as a popular distributed learning method. Federated Learning allows edge devices that collect data in real world scenarios to collaboratively train a model without necessarily sharing their raw data. This avoids or lowers communication cost as data and/or reduces the risk of data or privacy leaks or compromise. Recently, Hyper-Dimensional Computing (HDC) has emerged as lower complexity energy-efficient mechanisms to train machine learning (MIL) models and Federated training has been used to train Hyper-Dimensional models.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates an example of Federated Hyper-Dimensional Computing (HDC) training.

FIG. 1B illustrates another example of Federated Hyper-Dimensional Computing (HDC) training.

FIG. 2 illustrates an example of a method of training a hyperdimensional computing (HDC) model by one or more computing devices according to one embodiment.

FIG. 3 illustrates a flowchart of a computer system for training a hyperdimensional computing (HDC) model according to one embodiment.

FIG. 4 is a block diagram of an example of an apparatus, device, or machine upon which any one or more of the techniques (e.g., methodologies) discussed herein may perform.

FIG. 5 illustrates training and use of a machine-learning program in accordance with some example examples.

### DETAILED DESCRIPTION

In federated hyperdimensional computing (HDC), the size of the trained HDC model may be selected beforehand and fixed during the training process. While selecting larger sizes of the HDC model may lead to high predictive performance, it may also increase the amount of required computational, wireless, energy, and storage resources necessary to train the model. In the presence of such resource constraints, the predictive performance may be sacrificed by reducing the size of the model to meet system-level limitations. A Resource-Efficient Federated Hyperdimensional Computing (RE-FHDC) or Resource-Efficient Hyperdimensional Federated Learning (RE-HDFL) framework may alleviate such constraints by training and fine-tuning multiple smaller independent HDC sub-models. Such a framework may achieve comparable or higher predictive performance and lower processing times compared to conventional federated HDC implementation or training.

Systems and techniques described herein provide a federated HDC training procedure that avoids the training of a full-sized HDC model. The techniques described herein divides a full-sized HDC model into multiple HDC sub-models that may be independently trained with lower computational and communications costs. The HDC sub-models may be trained on different devices (e.g., different nodes or edge devices) and transmitted to another computing device, such as a server. The server may aggregate the HDC sub-models and concatenate the aggregated sub-models to create the full-sized HDC model. The server may then transmit the full-sized HDC model to the different devices. Upon the reception of the full-sized HDC model, the devices may select one or more identical subsets of positions of a full-sized HDC model and apply iterative training to the one or more subsets. A position may be a particular index of each hyperdimensional prototype or as a column of a C×D matrix representing the HDC model. In such an example, the positions may be the set of column indices. The subset of positions may represent the HDC sub-model which can be trained collaboratively. In order to train the HDC sub-models collaboratively, the users or devices select the same positions (the identical subsets discussed above) of the full-sized HDC model to iteratively train, which allows the sub-models may be trained in a federated manner.

Thus, the independent HDC sub-models may be successively trained and inference performed over the larger, concatenated HDC model. Therefore, the methods disclosed herein may require less resources of the participants or devices (e.g., for the mobile edge devices) and may result in increased or higher resource efficiency.

Instead of training a single D-dimensional HDC model during G_{T} global epochs, the users may train M=D/\hat{D} HDC sub-models of size \hat{D} during Ĝ=G_{T}/M global sub-epochs, one sub-model per G global sub-epochs. After G_{T} global iterations, the user may concatenate M trained \hat{D}-dimensional HDC sub-models into a full-sized D-dimensional HDC model and perform G_{R} global epochs of the retraining procedure by randomly selecting a subset of D₀ positions of the full-sized HDC model and applying the retraining procedure to this subset as it were an independent HDC sub-model. The randomly selected subset of D₀ positions may be changed at each global epoch. The randomly selected subset of D₀ positions is required to be synchronized between the users, which may be achieved via external orchestration or synchronizing initial states of random number generators. After these procedures, the users may use the full-sized D-dimensional HDC model to perform inference on the test data.

A single global epoch of the method may require less resources compared to the training of a full-sized D-dimensional HDC model while achieving comparable or higher predictive performance. The methods described herein may have the potential advantage of reducing energy consumption, accelerating local HDC model training, reducing communications costs, and/or mitigating the communications bottleneck that may be experienced during federated learning with a large number of participants or devices.

Throughout this disclosure, the following definitions may apply:

HDC model: A set of C D-dimensional prototypes {pᵢ} corresponding to C predicted classes.

Prototype: A D-dimensional vector representing the corresponding class. The prototype may be formed by aggregating HD representations of the data corresponding to the same class.

Distance measure: A quantitative measure of distance between two HD representations. In the proposed method, a cosine distance

$$dist ( {h}_{i} , {h}_{j} ) = 1 - \frac{〈 {h}_{i} {h}_{j} 〉}{{‖ {h}_{i} ‖}_{2} {‖ {h}_{j} ‖}_{2}}$$

may be used, where hᵢ and hⱼ represent D-dimensional HD vectors.

HDC transform/mapping: A function θ: R^{d}→R^{D} mapping the original d-dimensional data point into its D-dimensional hyperdimensional (HD) representation. In the proposed method, the HDC mapping θ(x)=cos(xW+φ)·sin(xW) may be used, where x represents the original d-dimensional data point, W represents a random d×D projection matrix sampled from a normal distribution, and <p represents a random D-dimensional vector sampled uniformly from [0,2π].

In the present system, N user devices may collaboratively train an HDC model having C prototypes of a size D corresponding to each of C predicted classes. The training procedure of the HDC model may include multiple procedures or operations: (i) the data transform, (ii) the prototype initialization, and (iii) the prototype retraining. The HDC inference procedure may compare the distance between C prototypes and the transformed test point and may select the class corresponding to the prototype with the smallest distance.

During the data transform procedure, the training data may be mapped into very large D-dimensional, or hyperdimensional vectors using the selected random projection-based HDC mapping θ: R^{d}→R^{D}. The employed random projection-based mapping may have several potential advantages over bit-level oriented mappings. First, the exploited matrix-to-matrix multiplication may allow transforming all the training and test data simultaneously, while the bit-level implementations involve the parallel processing of each of the data points separately. Second, the random projection operation may be efficiently implemented on the mobile/device system-on-chips (SoCs). That is, although achieving potentially lower energy efficiency and processing time gains compared to the dedicated hardware-oriented HDC architectures, the random projection-based mapping may become a more convenient option for general-purpose hardware, including resource-constrained mobile platforms.

During the prototype initialization, the training data Cᵢ corresponding to the i-th class may be aggregated into a single prototype pᵢ=Σ_{x∈C}_{ᵢ}α·θ(x), where α represents the learning rate. In the dataset, some data points may have high similarity but belong to different classes, which makes the corresponding class prototypes “fuzzy.” The goal of the further retraining procedure is to increase dissimilarity between the prototypes by reinforcing correct predictions and penalizing wrong or incorrect predictions.

When the distance Δⱼ(θ)=dist(θ, pⱼ) from the mapped data point θ=θ(x)∈Cᵢ to the wrong prototype pⱼ is smaller than the distance Δᵢ(θ) to the correct prototype pᵢ, then the prototypes are updated as:

pᵢ=pᵢ−α·(1−Δᵢ)·θ (1)

pⱼ=pⱼ+α·(1−Δⱼ)·θ (2)

The employed federated training may follow or utilize a FedAvg algorithm and may include G global and L local epochs. During each local epoch, the devices may perform L iterations of the HDC model retraining. After L local epochs, the devices may transmit their updated local HDC models to the parameter server. At the end of the global epoch t, the parameter server may aggregate the prototypes and the parameter server may return the averaged prototypes to the user devices, or:

$${p}_{i}^{( t + 1 )} = \frac{1}{N} {\sum }_{j = 1}^{N} {p}_{i , j}^{( t )} \qquad ( 3 )$$

The procedure may be readily adapted to the data and resource heterogeneity by setting a different number of local epochs L for each similar device. In an example, the user devices may use identical HDC mapping θ, which may be achieved, by sharing a common seed for the random number generators.

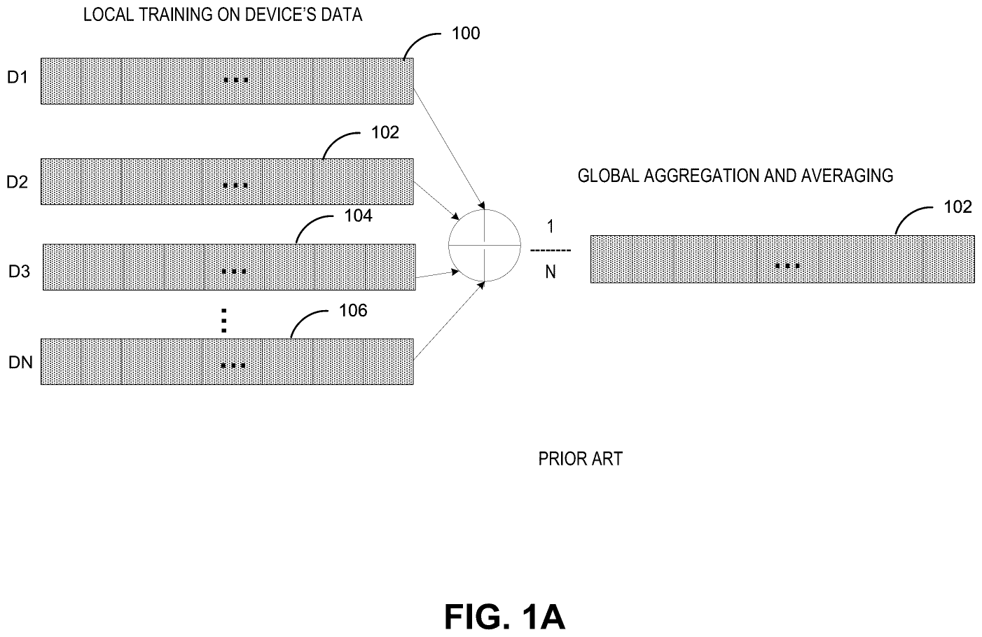

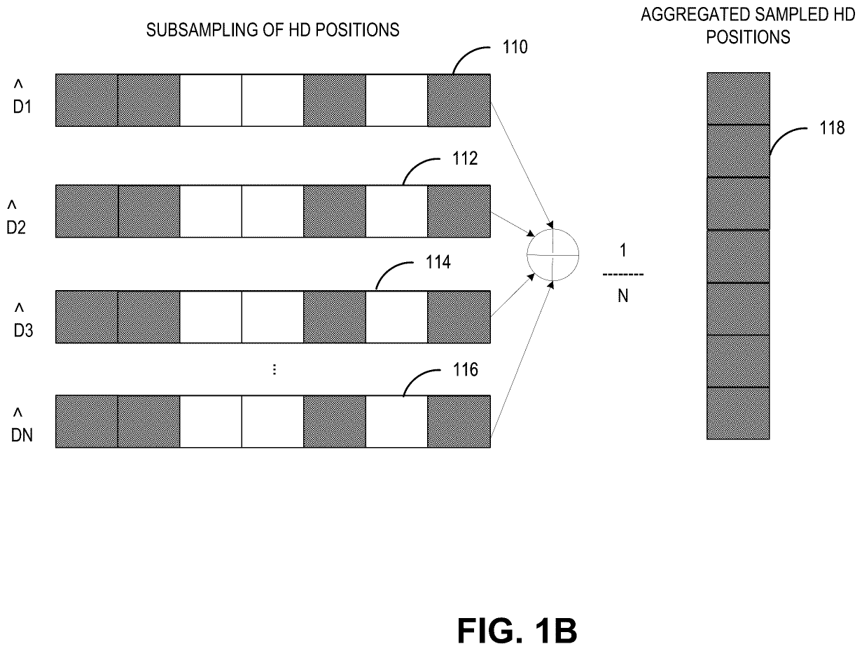

FIGS. 1A and 1B illustrate examples of Federated Hyper-Dimensional Computing (HDC) training. As illustrated in FIG. 1A, an HDC model may be trained over several iterations or epochs. In such an example, all of the positions of the HD vectors, 100, 102, 104, and 106 may be trained on a device (e.g., locally trained with the device's data). After several iterations of training on the device, the data may be transferred to an aggregator (e.g., a server or another computing device) where the data is aggregated with trained data from other devices (e.g., other edge devices or computing nodes), averaged into a trained HDC model 108. The trained HDC model 108 may then be transmitted back to the devices. In such an example, when the model is retrained, the entire model (e.g., every position of the HDC model) is retrained at one time. Such an example of federated training of an HDC model requires a large amount of computing resources to be used not only on the individual devices, but at the server level where the trained models are aggregated and averaged.

As illustrated in FIG. 1B, a Resource-Efficient Federated Hyperdimensional Computing RE-FHDC) method may successively train multiple independent HDC sub-models into a single D-dimensional HDC model and then may perform inference on the test data with the D-dimensional HDC model. Instead of training a single D-dimensional HDC model during G_{T} global epochs as shown in FIG. 1A, the users may train M=D/D HDC sub-models of size D during Ĝ=G_{T}/M global sub-epochs, one sub-model per Ĝ global sub-epochs. After G_{T} global iterations, the user may concatenate M trained \hat{D}-dimensional HDC sub-models into a full-sized D-dimensional HDC model and perform G_{R} global epochs of the retraining procedure by randomly selecting a subset of D₀ positions of the full-sized HDC model and applying the retraining procedure to this subset as it were an independent HDC sub-model. The randomly selected subset of D₀ positions may be changed at each global epoch. The randomly selected subset of D₀ positions is required to be synchronized between the users, which may be achieved via external orchestration or synchronizing initial states of random number generators. After these procedures, the users may use the full-sized D-dimensional HDC model to perform inference on the test data.

Thus, as illustrated in FIG. 1B, the device may train a sub-sampling of HD positions of the HD vectors 110, 112, 114, and 116. Thus, a subset of positions of an HDC model may be trained locally by the devices and transmitted to the server individually (e.g., as a first sub-model, a second sub-model, etc.). In an example, each of the federated devices may locally train identical sets of the sub-model using the same HD positions. The positions of the HD vectors that are trained in each sub model may be randomly selected by an orchestrator or a seed of a random number generator that is common to all the devices that are training the sub-models. The sub-models may be transmitted to a server or another communication device where they are aggregated and averaged to create the larger, complete, HDC model 118.

By transmitting individual trained sub-models from the devices to the server, the load on the communication channels between the devices and the server may be reduced, as less data may be transmitted at one time. Also, the computing resources used by the devices to locally train the sub-models may be reduced as they are not required to train the entire model during each epoch, and the server may use fewer computing resources as it may receive the trained sub-models in batches and concatenating a smaller amount of data at a time. After training and concatenating M HDC sub-models, the users or devices may fine-tune the concatenated HDC model (which is transmitted to the devices from the server) by sequentially selecting random subsets of D (or fewer positions) and retraining them in the same federated manner as described above.

In an example, the number of global sub-epochs Ĝ=G/M may be based on an assumption that the predictive performance of the HDC sub-model does not decrease in time. In another example, the evolution of the predictive performance may be monitored on the validation subset and proceed to training the next sub-model after it reaches the global minimum or starts overfitting. Examples of the performance of the proposed method on several datasets are displayed in Tables 1 and 2, below. In an example, datasets under the scenarios with identically independently distributed (i.i.d.) and non-i.i.d. data between the users are shown in Tables 1 and 2. In the i.i.d. scenario, the local data of the devices have identical class distributions, while under the non-i.i.d. scenario each device has only the selected amount of classes. As a feature extractor, a random Fourier feature mapping is used, which expands the original data to 3200 features. Throughout the experiments, the number of HDC features is fixed to D=5000 and the number of features for HDC sub-models is varied \hat{D}=[500, 1000, 2500]. To illustrate the advantage of the disclosed method over the baseline, a scenario in which the devices have to reduce the size D to [500, 1000, 2500] to meet the resource constraints is simulated.

TABLE 1
Comparison of accuracy of RE-HDFL and baseline federated HDC, i.i.d. setting

| | RE-HDFL D = 5K | | | Baseline Federated HDC | | | |
|---|---|---|---|---|---|---|---|
| | \hat{D} = 2.5K | \hat{D} = 1K | \hat{D} = 0.5K | D = 5K | D = 2.5K | D = 1K | D = 0.5K |
| MNIST | 0.972 | 0.969 | 0.963 | 0.965 | 0.959 | 0.940 | 0.913 |
| Fashion | 0.883 | 0.873 | 0.862 | 0.877 | 0.867 | 0.852 | 0.840 |
| MNIST | | | | | | | |
| CIFAR-10 | 0.492 | 0.484 | 0.447 | 0.499 | 0.477 | 0.440 | 0.417 |
| UCI HAR | 0.944 | 0.945 | 0.945 | 0.936 | 0.932 | 0.915 | 0.904 |
| HDC Model | 100 KB | 40 KB | 20 KB | 200 KB | 100 KB | 40 KB | 20 KB |
| Size | | | | | | | |

TABLE 2
Comparison of accuracy of RE-HDFL and baseline federated HDC, non-i.i.d. setting

| | RE-HDFL D = 5K | | | Baseline Federated HDC | | | |
|---|---|---|---|---|---|---|---|
| | \hat{D} = 2.5K | \hat{D} = 1K | \hat{D} = 0.5K | D = 5K | D = 2.5K | D = 1K | D = 0.5K |
| MNIST | 0.926 | 0.924 | 0.919 | 0.927 | 0.921 | 0.905 | 0.879 |
| Fashion | 0.778 | 0.775 | 0.773 | 0.779 | 0.776 | 0.774 | 0.762 |
| MNIST | | | | | | | |
| CIFAR-10 | 0.363 | 0.359 | 0.355 | 0.363 | 0.359 | 0.352 | 0.345 |
| UCI HAR | 0.922 | 0.901 | 0.861 | 0.898 | 0.888 | 0.876 | 0.862 |
| HDC Model | 100 KB | 40 KB | 20 KB | 200 KB | 100 KB | 40 KB | 20 KB |
| Size | | | | | | | |

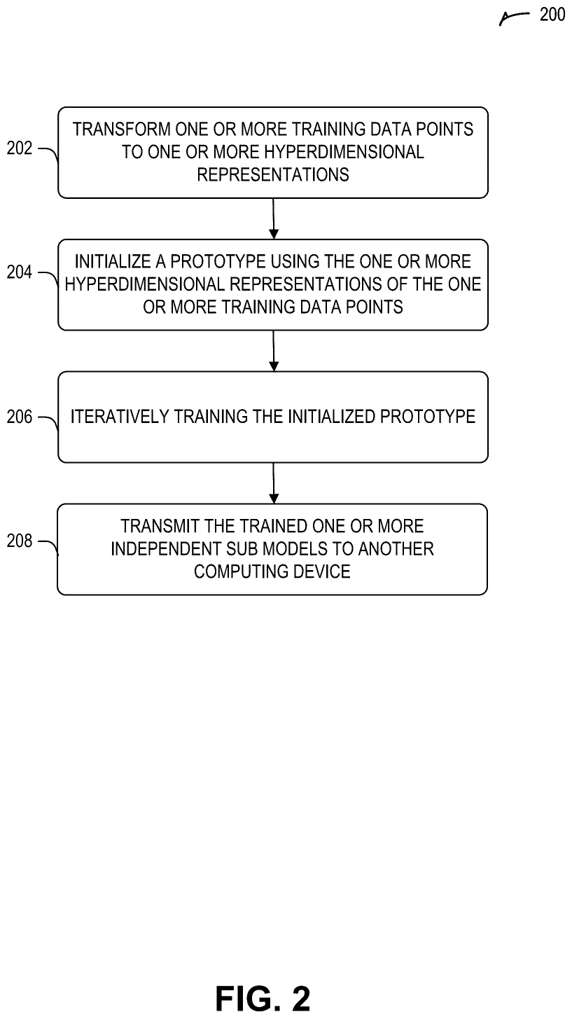

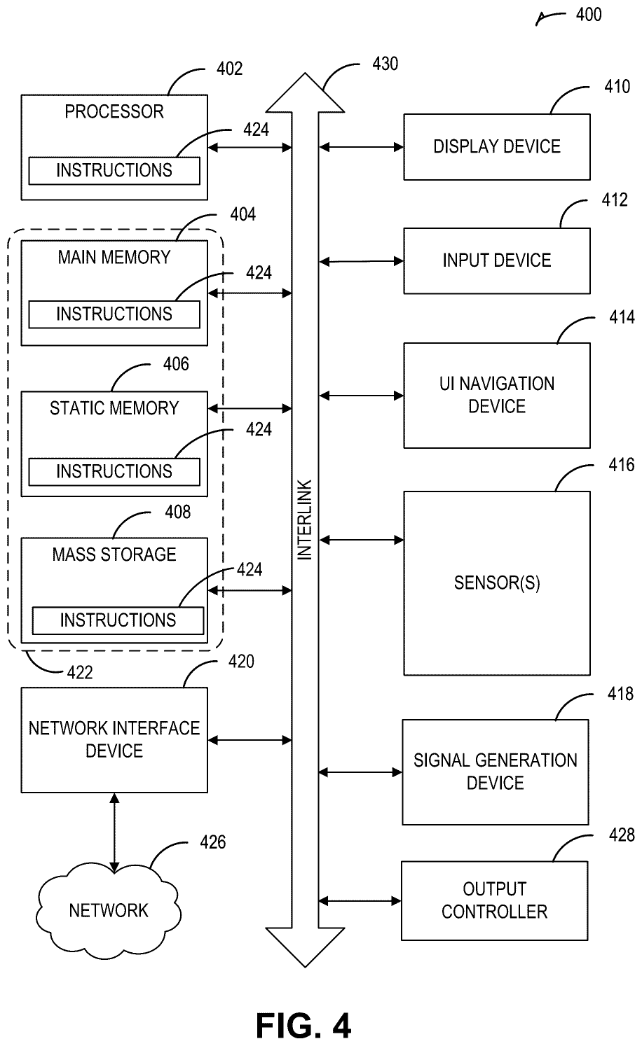

FIG. 2 illustrates an example of a method 200 of training a hyperdimensional computing (HDC) model by one or more computing devices according to one embodiment. The method 200 may include or comprise a number of Operations (202-208). These Operations are examples only, and the executed method may omit one or more of the listed Operations, may repeat Operations, may include other Operations, or may execute the Operations concurrently, substantially simultaneously, or in another order, as appropriate or desired. The Operations may be performed automatically by a processor or controller of a machine or computer, such as described below for FIG. 4.

Operation 202 may include transforming one or more training data points to one or more hyperdimensional representations. To transform the one or more training data points, the data points may be mapped into a hyperdimensional vector using random projection-based HDC mapping. The training data may be mapped into very large D-dimensional, or hyperdimensional vectors (e.g., a 5K vector) using a selected random projection-based HDC mapping θ: R^{d}→R^{D}. In the mapping, a function θ: R^{d}→R^{D} mapping the original d-dimensional data point into its D-dimensional hyperdimensional representation. The HDC mapping θ(x)=cos(xW+φ)·sin(xW) may be used, where x represents the original d-dimensional data point, W represents a random d×D projection matrix sampled from a normal distribution, and φ represents a random D-dimensional vector sampled uniformly from [0,2π].

Operation 204 may include initializing a prototype using the one or more hyperdimensional representations of the one or more training data points. During the initialization of the prototype, the one or more training data points may correspond to a class of the training data. The prototype may be formed by aggregating hyperdimensional representations of the data corresponding to the same class. During the prototype initialization, the training data Cᵢ corresponding to the i-th class may be aggregated into a single prototype pᵢ=Σ_{x∈C}_{ᵢ}α·θ(x), where α represents the learning rate. The class of the training data and one or more individual sub models may represent a portion of the larger HDC model, and the training data may be mapped only onto a portion of the hyperdimensional vector. Stated differently, when training sub models, only a part of the hyperdimensional vector may include data to be trained, while other portions of the vector may not be trained or may contain no data.

Operation 206 may include iteratively training the initialized prototype. The employed federated training may follow or utilize a FedAvg algorithm and may include G global and L local epochs. The one or more sub models may be trained on a device of a plurality of federated devices during the local epochs. Operation 208 may include transmitting the trained one or more independent sub models to another computing device. The another computing device may be a server, such as a parameter server, and may be communicatively coupled to the federated devices. In an example, after L local epochs, the devices may transmit their updated local HDC models to the parameter server. The parameter server may aggregate the trained one or more independent sub models from the device with one or more trained additional sub models received from one or more additional devices of the plurality of federated devices and concatenate the aggregated sub models to create the HDC model. The parameter server may then transmit the HDC model back to the plurality of federated devices. In an example, once the HDC model is transmitted back to the plurality of federated devices, the devices may retrain and refine the HDC model (or portions of the model) by randomly selecting portions of the HDC model to perform inference on model.

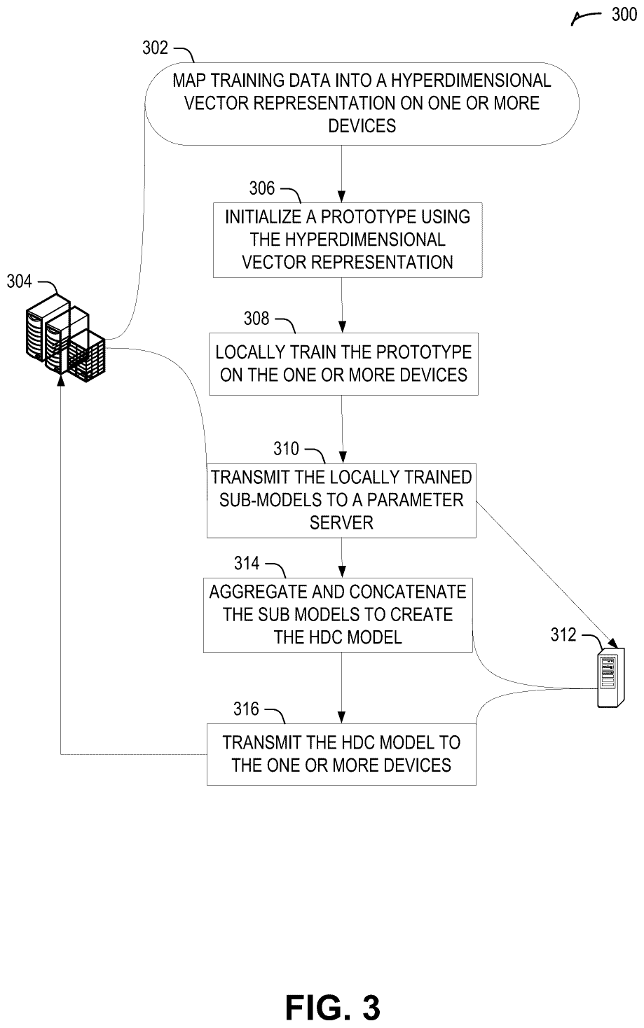

FIG. 3 illustrates a flowchart 300 of a computer system for training a hyperdimensional computing (HDC) model according to one embodiment. Operation 302 may include mapping training data into a hyperdimensional vector representation on one or more devices 304. The one or more training data points may be mapped into the hyperdimensional vector using random projection-based HDC mapping, and the position of the training data points in the hyperdimensional vector may be the same on each of the one or more devices 304. The one or more devices 304 may be Internet of Things (IoT) devices such as IoT nodes, edge nodes, or any other suitable network-connected computing device. Operation 306 may include initializing a prototype using the hyperdimensional vector representation.

Operation 308 may include locally training the prototype on the one or more devices 304. The initialized prototype may be an aggregate of a plurality of individual prototypes. To train the prototypes, a distance of one or more transformed data points to an incorrect prototype versus a distance to a correct prototype may be measured or determined. When the distance to the incorrect prototype is smaller than the distance to the correct prototype, at least one of the individual prototypes in the plurality of individual prototypes may be updated. The initialized prototype may include a sub-model of one or more independent sub models of an HDC model.

Operation 310 may include transmitting the locally trained sub models to another computing device, such as a parameter server 312. The parameter server 312 may be a physical server located at or near one or more of the one or more devices 304. The parameter server 312 may be a cloud-based server, or any computing device communicatively coupled to the one or more devices 304. At operation 314, the parameter server 312 may aggregate and concatenate the trained sub models received from the one or more devices 304 to create the HDC model. At operation 316, the parameter server 312 may transmit the HDC model to the one or more devices 304. In an example, once the HDC model is transmitted to the one or more devices 304, the one or more devices 304 may use the HDC model to perform inference on the test data to retrain at least a portion of the HDC model. To retrain or refine the HDC model, the one or more devices 304 may select a random subset of the HDC model and update the model using the training techniques described above and transmit an updated HDC model with the retrained data to the parameter server 312.

FIG. 4 is a block diagram of an example of an apparatus, device, or machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, field programmable gate array (FPGA), or any combination thereof), a main memory 404 and a static memory 406, some or all of which may communicate with each other via an interlink (e.g., bus) 430. The machine 400 may further include a display unit 410, an input device 412 (e.g., a keyboard or other alphanumeric input device), and a user interface (UI) navigation device 414 (e.g., a mouse). In an example, the display unit 410, input device 412 and UI navigation device 414 may be a touch screen display. The machine 400 may additionally include a storage device 408 (e.g., drive unit or other similar mass storage device or unit), a signal generation device 418 (e.g., a speaker), a network interface device 420 connected to a network 426, and one or more sensors 416, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 408 may include a machine readable medium 422 on which is stored one or more sets of data structures or instructions 424 (e.g., software) embodying or used by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 408 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424. The term “machine readable medium” may include any medium that is capable of storing, encoding, or carrying instructions for execution by the machine 400 and that cause the machine 400 to perform any one or more of the techniques of the present disclosure, or that is capable of storing, encoding, or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

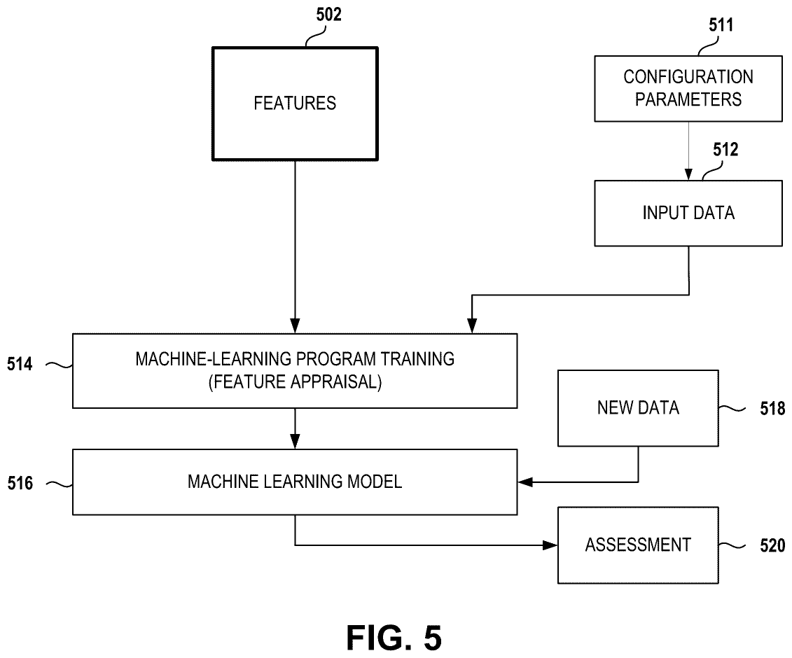

FIG. 5 illustrates the training and use of a machine-learning program, according to some example embodiments. In some example embodiments, machine-learning programs (MLPs), also referred to as machine-learning algorithms or tools, may be utilized to coordinate machines to train a hyperdimensional computing model.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Although example embodiments are presented with respect to a few machine-learning tools, the principles presented herein may be applied to other machine-learning tools.

Unsupervised ML includes the training of an ML algorithm using information that is neither classified nor labeled and allows the ML algorithm to act on that information without guidance. Unsupervised ML may be useful in exploratory analysis because it can automatically identify structure in data. Some common tasks for unsupervised ML include clustering, representation learning, and density estimation. Some examples of commonly used unsupervised-ML algorithms are K-means clustering, principal component analysis, and autoencoders. In some embodiments, example ML model 516 outputs actions for one or more robots to achieve a task, to identify an unsafe robot action or unsafe robot, detect a safety event, generate a safety factor, or the like.

The machine-learning algorithms may use data 512 (e.g., action primitives or interaction primitives, goal vector, reward, etc.) to find correlations among identified features 502 that affect the outcome. A feature 502 may be an individual measurable property of a phenomenon being observed. The concept of a feature may be related to that of an explanatory variable used in statistical techniques such as linear regression. Choosing informative, discriminating, and independent features is important for effective operation of ML in pattern recognition, classification, and regression. Features may be of different types, such as numeric features, strings, and graphs.

During training 514, the ML algorithm may analyze the input data 512 based on identified features 502 and configuration parameters 511 defined for the training (e.g., environmental data, state data, robot sensor data, etc.). The result of the training 514 is an ML model 516 that is capable of taking inputs to produce an output. Training an ML algorithm may involve analyzing data to find correlations. The ML algorithms may utilize the input data 512 to find correlations among the identified features 502 that affect the outcome or assessment 520. In some examples, the training data 512 may include labeled data, which is known data for one or more identified features 502 and one or more outcomes, such as accuracy of the input data.

The ML algorithms may explore many possible functions and parameters before finding what the ML algorithms identify to be the best correlations within the data; therefore, training may make use of large amounts of computing resources and time, such as many iterations for a Reinforcement Learning technique.

Many ML algorithms include configuration parameters 511, and the more complex the ML algorithm, the more parameters there are that are available to the user. The configuration parameters 511 define variables for an ML algorithm in the search for the best ML model. When the ML model 516 is used to perform an assessment (e.g., inference), new data 518 may be provided as an input to the ML model 516, and the ML model 516 may generate the assessment (e.g., inference) 520 as output.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

### ADDITIONAL NOTES & EXAMPLES

Example 1 is a device to train a hyperdimensional computing (HDC) model, comprising: memory; and processing circuitry to: train one or more independent sub models of the HDC model, the HDC model having a number of dimensions and a number of prototypes, each dimension of the HDC model corresponding to a protype of the number of prototypes; and transmit the trained one or more independent sub models of the HDC model to another computing device.

In Example 2, the subject matter of Example 1 optionally includes subject matter wherein the another computing device is to: aggregate the trained one or more independent sub models with one or more trained additional sub models received from one or more additional devices; concatenate the aggregated sub models to create the HDC model; and transmit the HDC model to the device and the one or more additional devices.

In Example 3, the subject matter of Example 2 optionally includes subject matter wherein the device and the one or more additional devices use the HDC model to perform an inference on test data stored locally at the one or more additional devices to retrain at least a portion of the HDC model.

In Example 4, the subject matter of any one or more of Examples 2-3 optionally includes subject matter wherein at least one of the device or the one or more additional devices selects a random subset of the HDC model to retrain the HDC model and transmits an updated HDC model to the another computing device.

In Example 5, the subject matter of any one or more of Examples 1-4 optionally includes subject matter wherein to train the one or more independent sub models of the HDC model, the processing circuitry is to: transform one or more training data points to one or more hyperdimensional representations; initialize a prototype using the one or more hyperdimensional representations of the one or more training data points, wherein the initialized prototype is a sub-model of the one or more independent sub models of the HDC model; and iteratively train the initialized prototype.

In Example 6, the subject matter of Example 5 optionally includes subject matter wherein to transform the one or more training data points to the one or more hyperdimensional representations comprises mapping the one or more training data points into a hyperdimensional vector using random projection-based HDC mapping.

In Example 7, the subject matter of any one or more of Examples 5-6 optionally includes subject matter wherein the prototype has one or more classes, the one or more training data points corresponding to a class of the prototype.

In Example 8, the subject matter of any one or more of Examples 5-7 optionally includes subject matter wherein the processing circuitry is further to: for a transformed data point of the one or more transformed data points: determine a distance between the transformed data points to each prototype of the HDC model; compare distances between the transformed data points and the prototypes of the HDC model; and select a prototype with a smallest distance based on comparison of the distances.

Example 9 is a method of training a hyperdimensional computing (HDC) model having a number of dimensions and a number of prototypes, each dimension of the HDC model corresponding to a protype of the number of prototypes, the method comprising, on a first device: transforming one or more training data points to one or more hyperdimensional representations; initializing a prototype using the one or more hyperdimensional representations of the one or more training data points, wherein the initialized prototype is a sub-model of one or more independent sub models of the HDC model; iteratively training the initialized prototype; and transmitting the trained one or more independent sub models to another computing device.

In Example 10, the subject matter of Example 9 optionally includes aggregate the one or more independent sub models with one or more additional sub-models received from one or more additional devices; concatenate the aggregated sub-models to create the HDC model; and transmit the HDC model to the first device and the one or more additional devices.

In Example 11, the subject matter of Example 10 optionally includes subject matter wherein the first device and the one or more additional devices use the HDC model to perform an inference on test data stored locally at the one or more additional devices to retrain at least a portion of the HDC model.

In Example 12, the subject matter of any one or more of Examples 10-11 optionally includes subject matter wherein at least one of the device or the one or more additional devices select a random subset of the HDC model to retrain the HDC model and transmits an updated HDC model to the another computing device.

In Example 13, the subject matter of any one or more of Examples 9-12 optionally includes subject matter wherein to transform the one or more training data points to the one or more hyperdimensional representations comprises mapping the one or more training data points into a hyperdimensional vector using random projection-based HDC mapping.

In Example 14, the subject matter of any one or more of Examples 9-13 optionally includes subject matter wherein the prototype has one or more classes, the one or more training data points corresponding to a class of the prototype.

In Example 15, the subject matter of any one or more of Examples 9-14 optionally includes subject matter wherein the initialized prototype is an aggregate of a plurality of individual prototypes, and wherein the method further comprises, for a transformed data point of the one or more transformed data point: determining a distance between the one or more transformed data points to each prototype of the HDC model; comparing distances between the transformed data points and the prototypes of the HDC model; and select a prototype with a smallest distance based on comparison of the distances.

Example 16 is at least one non-transitory computer-readable medium with instructions stored thereon, which, when executed by a processor of a computing device, cause the processor to: train one or more independent sub models of a hyperdimensional computing (HDC) model, the HDC model having a number of dimensions and a number of prototypes, each dimension of the HDC model corresponding to a protype of the number of prototypes; and transmit the one or more independent sub models of the HDC model to another computing device.

In Example 17, the subject matter of Example 16 optionally includes subject matter wherein the another computing device is to: aggregate the one or more independent sub models with one or more additional sub-models received from one or more additional devices; concatenate the aggregated sub-models to create the HDC model; and transmit the HDC model to the device and the one or more additional devices.

In Example 18, the subject matter of any one or more of Examples 16-17 optionally includes subject matter wherein to train the one or more independent sub models of the HDC model, instructions cause the processor to: transform one or more training data points to one or more hyperdimensional representations; initialize a prototype using the one or more hyperdimensional representations of the one or more training data points, wherein the initialized prototype is a sub-model of the one or more independent sub models of the HDC model; and iteratively train the initialized prototype.

In Example 19, the subject matter of Example 18 optionally includes subject matter wherein to transform the one or more training data points to the one or more hyperdimensional representations comprises mapping the one or more training data points into a hyperdimensional vector using random projection-based HDC mapping, and wherein the prototype includes one or more classes, the one or more training data points corresponding to a class of the prototype.

In Example 20, the subject matter of any one or more of Examples 18-19 optionally includes subject matter wherein the instructions further cause the processor to: determine a distance between the one or more transformed data points to each prototype of the HDC model; compare distances between the one or more transformed data points and the prototypes of the HDC model; and select a prototype with a smallest distance based on comparison of the distances.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A device to train a hyperdimensional computing (HDC) model, comprising:
memory; and
processing circuitry to:
train one or more independent sub models of the HDC model, the HDC model having a number of dimensions and a number of prototypes, each dimension of the HDC model corresponding to a protype of the number of prototypes; and
transmit the trained one or more independent sub models of the HDC model to another computing device.

2. The device of claim 1, wherein the another computing device is to:
aggregate the trained one or more independent sub models with one or more trained additional sub models received from one or more additional devices;
concatenate the aggregated sub models to create the HDC model; and
transmit the HDC model to the device and the one or more additional devices.

3. The device of claim 2, wherein the device and the one or more additional devices use the HDC model to perform an inference on test data stored locally at the one or more additional devices to retrain at least a portion of the HDC model.

4. The device of claim 2, wherein at least one of the device or the one or more additional devices selects a random subset of the HDC model to retrain the HDC model and transmits an updated HDC model to the another computing device.

5. The device of claim 1, wherein to train the one or more independent sub models of the HDC model, the processing circuitry is to:
transform one or more training data points to one or more hyperdimensional representations;
initialize a prototype using the one or more hyperdimensional representations of the one or more training data points, wherein the initialized prototype is a sub-model of the one or more independent sub models of the HDC model; and
iteratively train the initialized prototype.

6. The device of claim 5, wherein to transform the one or more training data points to the one or more hyperdimensional representations comprises mapping the one or more training data points into a hyperdimensional vector using random projection-based HDC mapping.

7. The device of claim 5, wherein the prototype has one or more classes, the one or more training data points corresponding to a class of the prototype.

8. The device of claim 5, wherein the processing circuitry is further to:
for a transformed data point of the one or more transformed data points:
determine a distance between the transformed data points to each prototype of the HDC model;
compare distances between the transformed data points and the prototypes of the HDC model; and
select a prototype with a smallest distance based on comparison of the distances.

9. A method of training a hyperdimensional computing (HDC) model having a number of dimensions and a number of prototypes, each dimension of the HDC model corresponding to a protype of the number of prototypes, the method comprising, on a first device:
transforming one or more training data points to one or more hyperdimensional representations;
initializing a prototype using the one or more hyperdimensional representations of the one or more training data points, wherein the initialized prototype is a sub-model of one or more independent sub models of the HDC model;
iteratively training the initialized prototype; and
transmitting the trained one or more independent sub models to another computing device.

10. The method of claim 9, further comprising:
aggregate the one or more independent sub models with one or more additional sub-models received from one or more additional devices;
concatenate the aggregated sub-models to create the HDC model; and
transmit the HDC model to the first device and the one or more additional devices.

11. The method of claim 10, wherein the first device and the one or more additional devices use the HDC model to perform an inference on test data stored locally at the one or more additional devices to retrain at least a portion of the HDC model.

12. The method of claim 10, wherein at least one of the device or the one or more additional devices select a random subset of the HDC model to retrain the HDC model and transmits an updated HDC model to the another computing device.

13. The method of claim 9, wherein to transform the one or more training data points to the one or more hyperdimensional representations comprises mapping the one or more training data points into a hyperdimensional vector using random projection-based HDC mapping.

14. The method of claim 9, wherein the prototype has one or more classes, the one or more training data points corresponding to a class of the prototype.

15. The method of claim 9, wherein the initialized prototype is an aggregate of a plurality of individual prototypes, and wherein the method further comprises, for a transformed data point of the one or more transformed data point:
determining a distance between the one or more transformed data points to each prototype of the HDC model;
comparing distances between the transformed data points and the prototypes of the HDC model; and
select a prototype with a smallest distance based on comparison of the distances.

16. At least one non-transitory computer-readable medium with instructions stored thereon, which, when executed by a processor of a computing device, cause the processor to:
train one or more independent sub models of a hyperdimensional computing (HDC) model, the HDC model having a number of dimensions and a number of prototypes, each dimension of the HDC model corresponding to a protype of the number of prototypes; and
transmit the one or more independent sub models of the HDC model to another computing device.

17. The at least one non-transitory computer-readable medium of claim 16, wherein the another computing device is to:
aggregate the one or more independent sub models with one or more additional sub-models received from one or more additional devices;
concatenate the aggregated sub-models to create the HDC model; and
transmit the HDC model to the device and the one or more additional devices.

18. The at least one non-transitory computer-readable medium of claim 16, wherein to train the one or more independent sub models of the HDC model, instructions cause the processor to:
transform one or more training data points to one or more hyperdimensional representations;
initialize a prototype using the one or more hyperdimensional representations of the one or more training data points, wherein the initialized prototype is a sub-model of the one or more independent sub models of the HDC model; and
iteratively train the initialized prototype.

19. The at least one non-transitory computer-readable medium of claim 18, wherein to transform the one or more training data points to the one or more hyperdimensional representations comprises mapping the one or more training data points into a hyperdimensional vector using random projection-based HDC mapping, and wherein the prototype includes one or more classes, the one or more training data points corresponding to a class of the prototype.

20. The at least one non-transitory computer-readable medium of claim 18, wherein the instructions further cause the processor to:
determine a distance between the one or more transformed data points to each prototype of the HDC model;
compare distances between the one or more transformed data points and the prototypes of the HDC model; and
select a prototype with a smallest distance based on comparison of the distances.
